(19) United States
(12) Patent Application Publication
(10) Pub. No.: US 2023/0231441 A1
(43) Pub. Date: Jul. 20, 2023

(54) Electro mechanical piston engine

(71) Applicant: Eric Brown, Bridgewater, MA (US)

(72) Inventor: Eric Brown, Bridgewater, MA (US)

(21) Appl. No.: 17/300,996

(22) Filed: Jan. 18, 2022

(51) Int. Cl. H02K 7/075; H02K 7/08; H02K 7/116

(52) U.S. Cl. CPC H02K 7/075; H02K 7/08; H02K 7/116

(57) ABSTRACT

What is new within this engine in th field of the magnetic engine is that it uses the ball bearing gear piston as the catalyst to make the engine work, by this we mean that the ball bearing gear piston is the workhorse of the engine being that it moves to push down the piston to turn the crank.

### BACKGROUND OF THE INVENTION

Pertaining to the background of the invention this is an invention that will be used in the field of power generation, or better yet used in a power plant to generate electricity. In essence this is a magnetic engine.

Although I receive most of my information from the Encyclopedia Americana and the Mcgraw Hill Encyclopedia of science and technology, there really is no source of information that is written about this engine or related matter because there is nothing out there in public that is currently like it, except my other engine the Electro Dynamic Piston Engine which operates differently than this engine yet some things are similar, such as the power source that delivers energy to the cylinders.

### BRIEF SUMMARY OF THE INVENTION

But as far as the engines of today that use fuel to power them, my engine is different because it uses the power of the generator along with a gearing system to create force which powers the pistons to push the crank to reciprocate. With that said the object of the egine is to replace fossil fuel engines. And because other mechanical engines use fuel to operate this makes my engine more desirable because of no need for fuel.

### BRIEF DESCRIPTION OF THE DRAWINGS

There are three drawings being submitted and they are numbered as FIG. 4d, FIG. 5e and FIG. 3c. In FIG. 4d is shown the side view with 3 cylinders showing of a 6 cylinder engine block, but what must be kept in mind is that only 3 cylinders are shown to show the inside of each cylinder within the main focus.

FIG. 5e is just one cylinder shown with larger view of the inside of the cylinder.

Inside 4d is shown the generator, spinning spindle shaft which the ball bearing gear piston slides down and also shown are the top piston rod along with piston and rod the crankshaft.

FIG. 3c is the power controller, this is where the cylinder generator gets its power to work, inside it are the generators, transformers and gear shafts that make the generators spin, also is the power controller control hubs that decide where energy is sent to each cylinder.

### DETAILED DESCRIPTION OF THE INVENTION

What will be explained first is the interaction within the engine to observe how we obtain power.

The electricity comes down from the power controller to the cylinder generator 07 which causes the spinning spindle shaft 08 to spin causing the ball bearing gear piston 09 to rotate downward pushing the top piston rods 11, thereby causing the bottom piston 12 to push down on the crank 14 creating a centrifical force.

Because the ball bearing gear piston pushes the bottom piston to create force is what sets it apart from other engines. The improvement that is achieved here is we get the downward motion from the ball bearing gear piston which causes a centrifical force on the crank.

The engine block can be constructed of aluminum or be of a ceramic composition there-by limiting the affects of magnetism through-out the engine block.

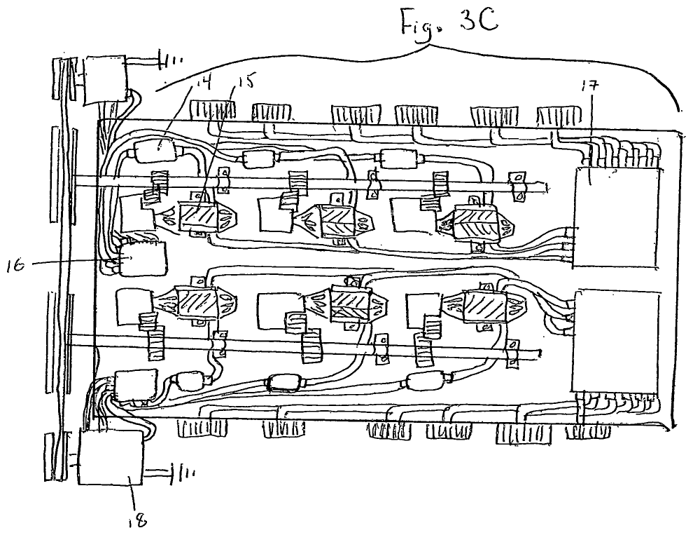

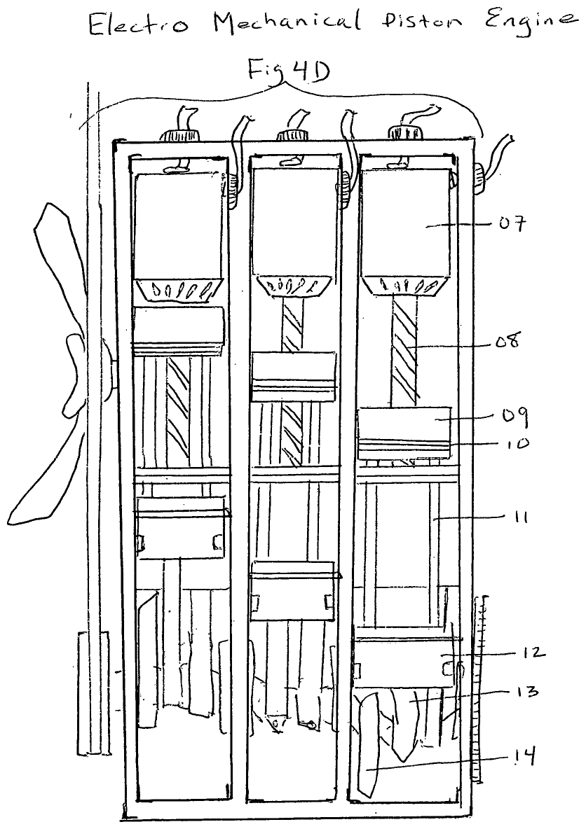

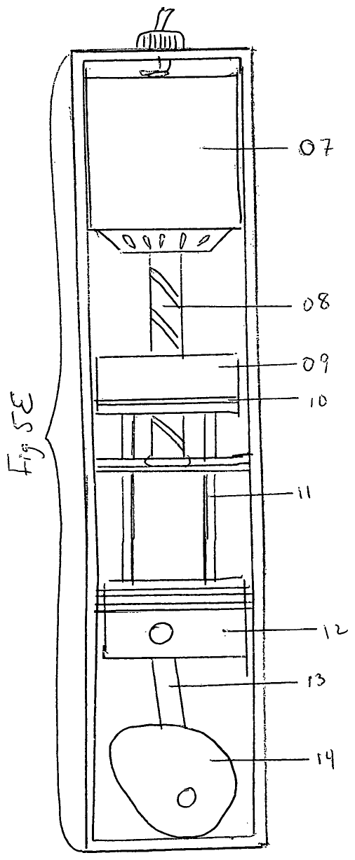

This is a notice to let the reader know that all the numbers of FIG. 4d and FIG. 5e are all the same because they depict the apparatus's within the machine. FIG. 5e is just an expanded view of FIG. 4d.

Here are the numbers matched up with the name of each part within the engine.

07 the generator

08 the spinning spindle shaft

09 the ball bearing gear piston

10 the ball bearing hub

11 the top piston rod

12 the bottom piston

13 the bottom piston rod

14 the crank

The top numbers and parts are for FIG. 4d and FIG. 5e.

This is another explanation of numbers corresponding with the part of FIG. 3c parts within the apparatus.

Here are the numbers matched up with the name of each part within the engine. These are all the parts within the FIG. 3c.

14 the transformer

15 the generators

16 the generator cable hub

17 the power distributor

18 the main feed genrators

1. I claim that this magnetic engine works differently from all other magnetic engines. The fact that it uses the ball bearing gear piston as the catalyst to push the bottom piston down to turn the crank is what makes it different from all other magnetic engines.
